(19) United States
(12) Patent Application Publication
(10) Pub. No.: US 2015/0073935 A1
(43) Pub. Date: Mar. 12, 2015

(54) INFORMATION PROCESSING APPARATUS, CONSUMABLES ORDERING METHOD, AND COMPUTER PROGRAM PRODUCT

(71) Applicants: Yuto SHIBATA, Kanagawa (JP); Noboru Tamura, Kanagawa (JP); Yuka Saito, Tokyo (JP); Hiroya Uruta, Tokyo (JP); Yasuyuki Igarashi, Kanagawa (JP); Daisuke Masui, Kanagawa (JP); Masashi Taniguchi, Kanagawa (JP); Naoya Tamura, Tokyo (JP); Chan Gu, Tokyo (JP)

(72) Inventors: Yuto SHIBATA, Kanagawa (JP); Noboru Tamura, Kanagawa (JP); Yuka Saito, Tokyo (JP); Hiroya Uruta, Tokyo (JP); Yasuyuki Igarashi, Kanagawa (JP); Daisuke Masui, Kanagawa (JP); Masashi Taniguchi, Kanagawa (JP); Naoya Tamura, Tokyo (JP); Chan Gu, Tokyo (JP)

(21) Appl. No.: 14/482,133

(22) Filed: Sep. 10, 2014

(30) Foreign Application Priority Data
Sep. 11, 2013 (JP) 2013-188770
May 16, 2014 (JP) 2014-102281

(51) Int. Cl. G06Q 30/06; G06Q 10/08

(52) U.S. Cl. CPC G06Q 30/0633; G06Q 10/087
USPC 705/26.8

(57) ABSTRACT

An information processing apparatus includes: a storage control unit that stores, in a storage medium, device number information for identifying the information processing apparatus and a consumables list of consumables available in the information processing apparatus identified by the device number information; and a processing unit that acquires the consumables list from an order receiving server via a network, causes the consumables list to be displayed, and send order information received from the user to the order receiving server when being connected to the network, causes the consumables list to be displayed and causes the storage control unit to store order information received from the user when being not connected to the network, and sends the order information stored to the order receiving server when the information processing apparatus is recovered from a state of being not connected to the network to a state of being connected to the network.

### CROSS-REFERENCE TO RELATED APPLICATIONS

The present application claims priority to and incorporates by reference the entire contents of Japanese Patent Application No. 2013-188770 filed in Japan on Sep. 11, 2013 and Japanese Patent Application No. 2014-102281 filed in Japan on May 16, 2014.

### BACKGROUND OF THE INVENTION

1. Field of the Invention

The present invention relates to an information processing apparatus, a consumables ordering method, and a computer program product.

2. Description of the Related Art

When consumables of the information processing apparatus such as an image forming apparatus run out or decrease, a user has been required to place an order to a person in charge, or to a vendor directly. Recently, technology capable of managing and ordering consumables via the panel of the information processing apparatus without placing a burden on the user, has been provided.

For example, in Japanese Laid-open Patent Publication No. 2002-288494, a system, which receives an order of consumables from an operation unit of the image forming apparatus and orders consumables to an order receiving server via a network, has been disclosed and known. The technology has been known in which only consumables available in the image forming apparatus being operated are displayed at the operation unit by sending a device number specific to the image forming apparatus from the image forming apparatus to the order receiving server and acquiring consumables information corresponding to the device.

However, in the order of consumables by the conventional information processing apparatus, there has been a problem that the user is unable to perform the ordering procedure since it is not possible to acquire a consumables list available in the device from the order receiving server when the network is not connected, for example, when the network has not yet been connected at the beginning of the introduction or when the network is terminated for some reasons.

In view of the above, there is a need to provide an information processing apparatus with which the user is capable of ordering consumables even when the network is disconnected.

### SUMMARY OF THE INVENTION

It is an object of the present invention to at least partially solve the problems in the conventional technology.

An information processing apparatus includes: a communication unit to be connected to an order receiving server via a network; an operation display control unit that performs control of reception of an input from a user and display of data; a storage control unit that stores, in a storage medium, device number information for identifying the information processing apparatus and a consumables list of consumables available in the information processing apparatus identified by the device number information, the consumables list being acquired from the order receiving server; and a processing unit that acquires the consumables list from the order receiving server, instruct the operation display control unit to display the consumables list acquired, and send order information received from the user to the order receiving server when being connected to the network, instructs the operation display control unit to display the consumables list stored and causes the storage control unit to store the order information received from the user when being not connected to the network, and sends the order information stored to the order receiving server when the information processing apparatus is recovered from a state of being not connected to the network to a state of being connected to the network.

A consumables ordering method includes: connecting to an order receiving server via a network; receiving an input from a user and performing control to display data by an operation display control unit; storing, in a storage medium, device number information for identifying an information processing apparatus and a consumables list of consumables available in the information processing apparatus identified by the device number information by a storage control unit, the consumables list being acquired from the order receiving server; acquiring the consumables list from the order receiving server, instructing the operation display control unit to display the consumables list acquired, and sending order information received from the user to the order receiving server when being connected to the network; instructing the operation display control unit to display the consumables list stored and causing the storage control unit to store the order information received from the user when being not connected to the network; and sending the order information stored to the order receiving server when the information processing apparatus is recovered from a state of being not connected to the network to a state of being connected to the network.

A computer program product includes a non-transitory computer-readable medium containing an information processing program. The program causing a computer included in an information processing apparatus to perform: connecting to an order receiving server via a network; receiving an input from a user and performing control to display data by an operation display control unit; storing, in a storage medium, device number information for identifying an information processing apparatus and a consumables list of consumables available in the information processing apparatus identified by the device number information by a storage control unit, the consumables list being acquired from the order receiving server; acquiring the consumables list from the order receiving server, instructing the operation display control unit to display the consumables list acquired, and sending order information received from the user to the order receiving server when being connected to the network; instructing the operation display control unit to display the consumables list stored and causing the storage control unit to store the order information received from the user when being not connected to the network; and sending the order information stored to the order receiving server when the information processing apparatus is recovered from a state of being not connected to the network to a state of being connected to the network.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a system configuration diagram of an image forming apparatus according to an embodiment;

FIG. 2 is a hardware configuration diagram of the image forming apparatus according to the embodiment;

FIG. 3 is a schematic diagram illustrating a software configuration of the image forming apparatus according to the embodiment;

FIG. 4 is a block diagram illustrating a software configuration of the image forming apparatus according to the embodiment;

FIG. 5A is a diagram illustrating an outline of an order work for consumables of the image forming apparatus according to the embodiment;

FIG. 5B is a diagram illustrating an outline of an order work for consumables of the image forming apparatus according to the embodiment;

FIG. 6 is a sequence diagram illustrating a processing flow of ordering consumables in the image forming apparatus according to the embodiment in a state being connected to a network;

FIG. 7 is a sequence diagram illustrating a processing flow of ordering consumables in the image forming apparatus according to the embodiment in a state where the network connection is disconnected;

FIG. 8 is a diagram illustrating an example of an error display displayed in a case where the network is not connected to the image forming apparatus according to the embodiment;

FIG. 9 is a sequence diagram illustrating a processing flow of ordering consumables when the image forming apparatus according to the embodiment is recovered from a state where the network connection is disconnected to a state where the network connection is connected;

FIG. 10 is a sequence diagram illustrating a processing flow of ordering consumables which confirms whether there are any changes in a consumables list in an image forming apparatus according to a second embodiment;

FIG. 11 is a sequence diagram illustrating a processing flow of ordering consumables which confirms whether there are any changes in the consumables list in the image forming apparatus according to the second embodiment;

FIG. 12 is a sequence diagram illustrating a processing flow of ordering consumables which confirms whether there are any changes in the consumables list in the image forming apparatus according to the second embodiment;

FIG. 13 is a block diagram illustrating a software configuration of an image forming apparatus according to a third embodiment;

FIG. 14 is a diagram illustrating an example of a consumables list acquired by the image forming apparatus according to the third embodiment; and

FIG. 15 is a sequence diagram illustrating a processing flow of acquiring the consumables list from an external medium by the image forming apparatus according to the third embodiment.

### DETAILED DESCRIPTION OF THE PREFERRED EMBODIMENTS

Embodiments of an image forming apparatus as an information processing apparatus will be described in detail hereinafter with reference to the attached drawings. An example applied to the image forming apparatus as the information processing apparatus will be described below, but the applicable devices are not limited to the image forming apparatus.

### First Embodiment

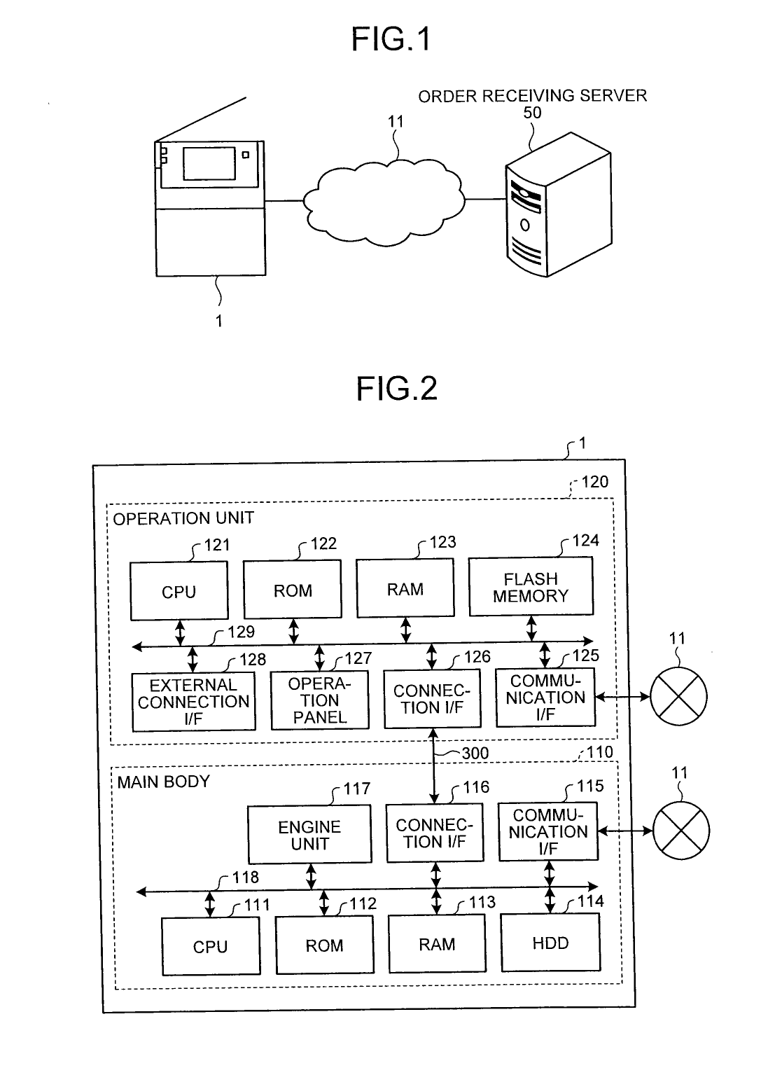

First, a system configuration using an image forming apparatus according to the present embodiment will be described. FIG. 1 is a system configuration diagram of the image forming apparatus according to the first embodiment. As illustrated in FIG. 1, the image forming apparatus 1 is connected to an order receiving server 50 via a network 11 such as the Internet.

Next, a hardware configuration of the image forming apparatus 1 will be described using FIG. 2. FIG. 2 is a hardware configuration diagram of the image forming apparatus according to the first embodiment. As illustrated in FIG. 2, the image forming apparatus 1 is provided with a main body 110 which is capable of realizing various functions such as a copy function, a scanner function, a facsimile function, and a printer function, and an operation unit 120 which receives an operation from a user. Receiving the operation from the user is a concept which includes receiving information (including signals indicating a coordinate value of a screen, etc.) input in response to the operation of the user.

The main body 110 and the operation unit 120 are connected so as to communicate mutually via a dedicated communication path 300. The communication path 300 may be, for example, of universal serial bus (USB) standard, or an arbitrary wired or wireless standard.

The main body 110 is capable of performing the operation in response to the operation received at the operation unit 120. In addition, the main body 110 can communicate with an external device such as a client personal computer (PC) and can perform the operation in response to an instruction received from the external device.

First, the hardware configuration of the main body 110 will be described. As illustrated in FIG. 2, the main body 110 includes a central processing unit (CPU) 111, a read only memory (ROM) 112, a random access memory (RAM) 113, a hard disk drive (HDD) 114, a communication interface (I/F) 115, a connection interface (I/F) 116, and an engine unit 117, which are connected mutually via a system bus 118.

The CPU 111 totally controls the operation of the main body 110. The CPU 111 controls the whole operation of the main body 110 by executing a program stored in the ROM 112, the HDD 114, etc., using the RAM 113 as a work area, thereby realizing various functions mentioned above such as the copy function, the scanner function, the facsimile function, and the printer function.

The communication I/F 115 is an interface for connecting to the network 11. The connection I/F 116 is an interface for communicating with the operation unit 120 via the communication path 300.

The engine unit 117 is a piece of hardware which performs processes other than versatile information processing and communication in order to realize the copy function, the scanner function, the facsimile function, and the printer function. The image forming apparatus 1 is provided with: for example, a scanner unit (image reading unit) which reads an image of the document by scanning; a plotter unit (image forming unit) which performs printing on a sheet material such as paper; and a facsimile unit which performs facsimile communication. In addition, a specific option such as a finisher for sorting a printed sheet material or an automatic document feeder (ADF) for feeding document automatically may be provided.

Next, the hardware configuration of the operation unit 120 will be described. As illustrated in FIG. 2, the operation unit 120 is provided with a CPU 121, a ROM 122, a RAM 123, a flash memory 124, a communication I/F 125, a connection I/F 126, an operation panel 127, and an external connection I/F 128, which are connected mutually via a system bus 129.

The CPU 121 totally controls the operation of the operation unit 120. The CPU 121 controls the whole operation of the operation unit 120 by executing a program stored in the ROM 122, the flash memory 124, etc., using the RAM 123 as a work area, thereby realizing various functions mentioned below such as displaying information (image) in response to an input received from the user.

The communication I/F 125 is an interface for connecting to the network 11. The connection I/F 126 is an interface for communicating with the main body 110 via the communication path 300. The external connection I/F 128 is an interface for connecting to the external device which is connected to the image forming apparatus 1.

The operation panel 127 displays various information (for example, information in response to the operation received, information indicating operation condition of the image forming apparatus 1, and information indicating setting condition) in addition to receiving various inputs in response to the operation from the user. In this example, the operation panel 127 includes a liquid crystal display (LCD) mounted with a touch panel function, but is not limited thereto. For example, the operation panel 127 may include an organic EL display device mounted with the touch panel function. Moreover, an operation unit for a hardware key, etc., and a display unit for a lamp, etc. may be provided in addition to or in place of the above.

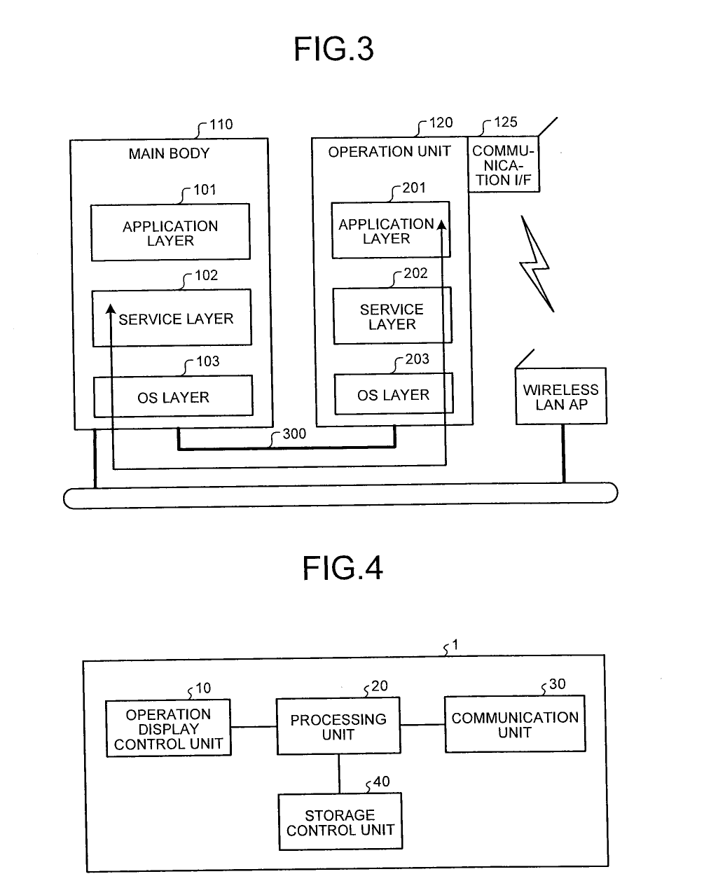

Next, a software configuration of the image forming apparatus 1 will be described. FIG. 3 is a schematic diagram illustrating an example of the software configuration of the image forming apparatus according to the first embodiment. As illustrated in FIG. 3, the main body 110 includes an application layer 101, a service layer 102, and an OS layer 103. The entities of the application layer 101, the service layer 102, and the OS layer 103 are various pieces of software stored in the ROM 112, the HDD 114, etc. The CPU 111 executes these pieces of software, thereby providing various functions.

The software of the application layer 101 is application software (hereinafter sometimes simply referred to as application) for providing a predetermined function by operating a hardware resource. Examples of the applications include a copy application for providing the copy function, a scanner application for providing the scanner function, a facsimile application for providing the facsimile function, and a printer application for providing the printer function.

The software of the service layer 102 is interposed between the application layer 101 and the OS layer 103, and is the software for providing the application with an interface for utilizing the hardware resource included in the main body 110. More specifically, the software provides the functions of receiving the operation request and arbitrating the operation request to the hardware resource. The operation request which the service layer 102 receives is considered to be a request of reading by a scanner, printing by a plotter, or the like.

The interface function of the service layer 102 is provided not only for the application layer 101 of the main body 110, but also for the application layer 201 of the operation unit 120. That is, the application layer 201 (application) of the operation unit 120 can also realize the function utilizing the hardware resource (for example, the engine unit 117) of the main body 110 via the interface function of the service layer 102.

The software of the OS layer 103 is the basic software (operating system) for providing a basic function of controlling the hardware included in the main body 110. The software of the service layer 102 converts a use request of the hardware resource from the various applications into a command which the OS layer 103 can interpret and passes it to the OS layer 103. Then, by executing the command by the software of the OS layer 103, the hardware resource performs the operation according to the request of the application.

Similarly, the operation unit 120 includes an application layer 201, a service layer 202, and an OS layer 203. The application layer 201, the service layer 202, and the OS layer 203 included in the operation unit 120 have the same layered structures as those of the main body 110. However, the function provided by the application of the application layer 201 and a variety of the operation requests receivable at the service layer 202 are different from those of the main body 110. The application of the application layer 201 may be the software for providing a predetermined function by operating the hardware resource included in the operation unit 120. However, the application of the application layer 201 is the software for mainly providing a user interface (UI) function for operating and displaying functions (the copy function, the scanner function, the facsimile function, and the printer function) included in the main body 110.

In the present embodiment, the software of the OS layer 103 of the main body 110 and the software of the OS layer 203 of the operation unit 120 differ from each other in order to keep independence of functions. That is, the main body 110 and the operation unit 120 operate independently of each other by separate operating systems. For example, Linux (registered trademark) can be used as the software of the OS layer 103 of the main body 110, and Android (registered trademark) can be used as the software of the OS layer 203 of the operation unit 120.

As described above, in the image forming apparatus 1 of the present embodiment, the main body 110 and the operation unit 120 operate by different operating systems. Therefore, the communication between the main body 110 and the operation unit 120 is performed as communication between different devices, not as inter-process communication within the common device. An operation to transmit information (content of the instruction from the user), received by the operation unit 120, to the main body 110 and an operation of the main body 110 to notify the operation unit 120 of an event are included in this communication. Here, functions of the main body 110 can be used by command communication to the main body 110 performed by the operation unit 120. In addition, the event, of which the operation unit 120 is notified by the main body 110, includes executing state of the operation by the main body 110 and the content set for the main body 110.

In addition, in the present embodiment, power supply to the operation unit 120 is made from the main body 110 via the communication path 300. Therefore, power supply controls of the operation unit 120 and the main body 110 can be conducted separately (independently).

Next, a functional configuration of the image forming apparatus 1 will be described. FIG. 4 is a block diagram illustrating the functional configuration of software of the image forming apparatus 1. As illustrated in FIG. 4, an operation display control unit 10 controls a panel display for information operation provided on the image forming apparatus 1. In addition, the operation display control unit 10 receives operation input from the user and reports an operation content received to a processing unit 20. The processing unit 20 controls the operation of the image forming apparatus 1 in response to the input from the user. A communication unit 30 controls data exchanging with external via the communication I/F 115. A storage control unit 40 performs processing of storing the consumables list, corresponding to device number information of the device or corresponding to the device, on the ROM 112 or the HDD 114, which is a non-volatile memory. The above-described functions may be realized by the software or the hardware such as an electronic circuit.

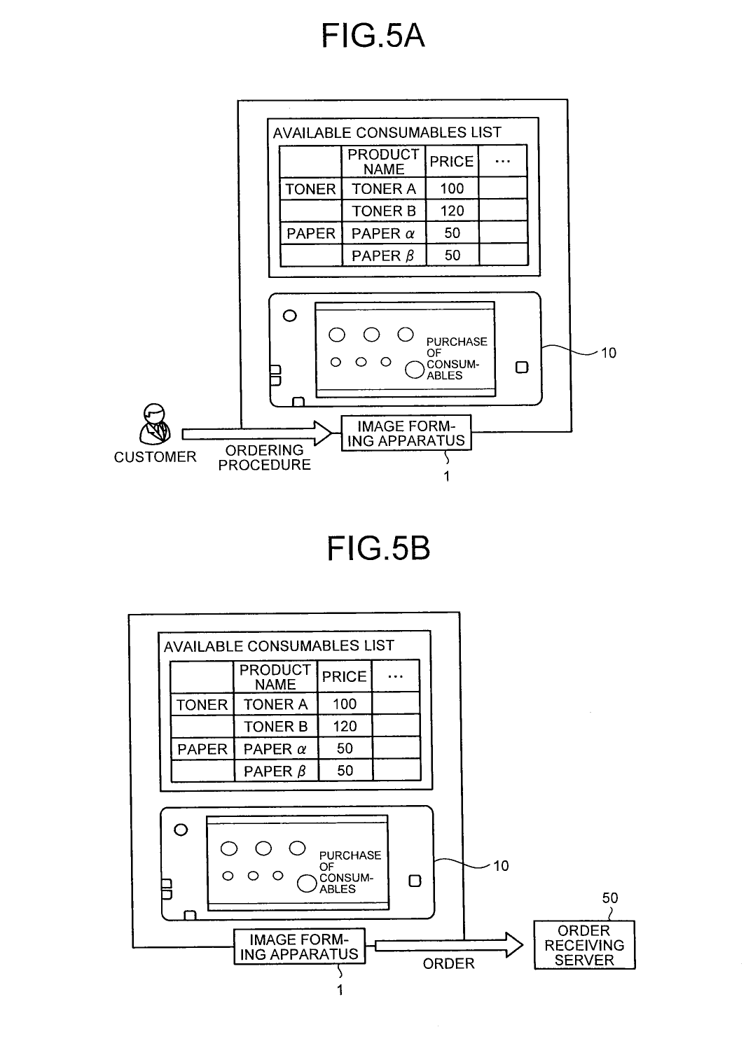

Next, the utilization status of ordering consumables from this image forming apparatus 1 will be described using FIGS. 5A and 5B. As illustrated in FIGS. 5A and 5B, the consumables list available in and corresponding to the image forming apparatus 1 has been stored in the image forming apparatus 1. A customer selects a product from the consumables list displayed at the panel by the operation display control unit 10 and performs an ordering procedure. The image forming apparatus 1, which has received the ordering procedure, sends the order information to an order receiving server 50 via the network.

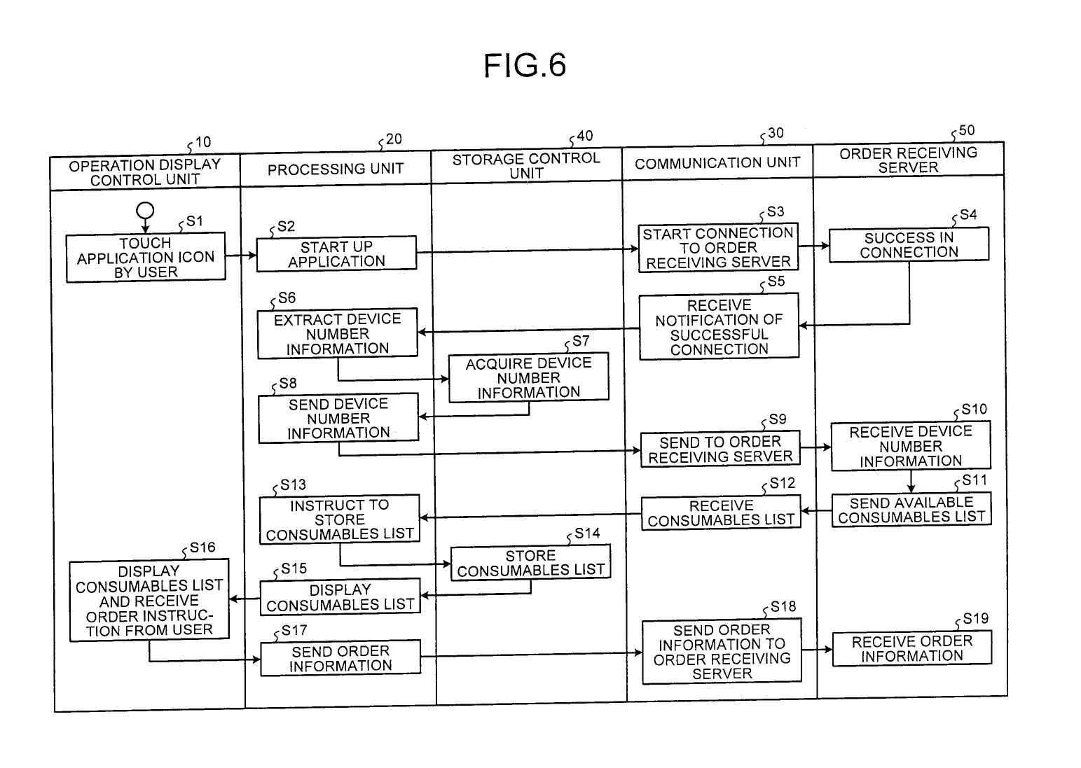

FIG. 6 is a sequence diagram illustrating a processing flow of ordering consumables according to the present embodiment. FIG. 6 is a processing flow in a state where the image forming apparatus 1 is connected to the network. As illustrated in FIG. 6, at first, a process is started by the user touching an icon of an application for ordering consumables via the operation display control unit 10 (Step S1). Next, the processing unit 20 starts up the application (Step S2). The processing unit 20 sends the instruction to the communication unit 30 to connect to the order receiving server 50 via the application started up (Step S3). The communication unit 30 performs the connection processing with the order receiving server 50. When the communication unit 30 succeeds in the connection with the order receiving server 50 (Step S4), the communication unit 30 receives a notification of successful connection (Step S5).

Upon receiving the notification of successful connection, the communication unit 30 sends the notification to the application which the processing unit 20 starts up. Then the processing unit 20 requests the storage control unit 40 to extract the device number information (Step S6). Upon receiving a request of acquiring the device number information from the processing unit 20, the storage control unit 40 acquires the device number information from the non-volatile memory (ROM 112, HDD 114) and sends it to the processing unit 20 (Step S7). Upon receiving the device number information, the processing unit 20 requests to send the received device number information to the order receiving server via the communication unit 30 (Steps S8, S9). Upon receiving the device number information (Step S10), the order receiving server 50 sends the consumables list available in the image forming apparatus 1 which is identified by the device number information (Step S11). The communication unit 30 receives the consumables list from the order receiving server 50 (Step S12). The processing unit 20 sends an instruction to store the consumables list to the storage control unit 40 (Step S13). The storage control unit 40 stores the consumables list (Step S14). The processing unit 20 displays the consumables list (Step S15).

The operation display control unit 10 displays the consumables list and receives an order instruction from the user (Step S16). The processing unit 20 orders the order information to the order receiving server 50 via the communication unit 30 based on the order instruction received (Steps S17, S18). The order receiving server 50 receives the order information (Step S19).

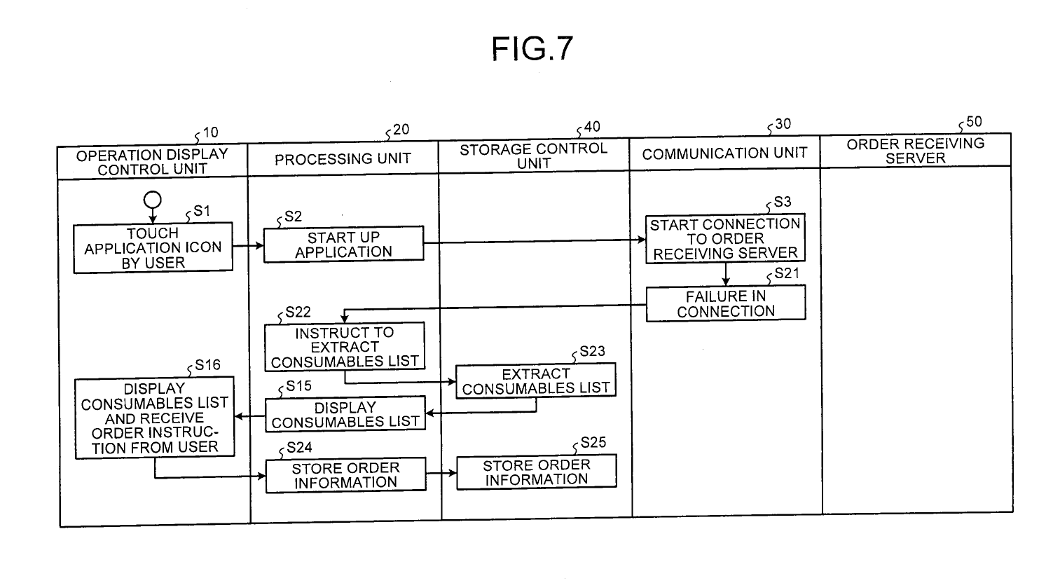

Although FIG. 6 illustrates the process when the network connection is possible, FIG. 7 describes a processing flow in a circumstance where the network connection is impossible. The same numerals are provided for the same processes in FIG. 6, and the different parts will be described. As illustrated in FIG. 7, when the connection to the order receiving server 50 fails (Step S21), the processing unit 20 sends an instruction to extract the consumables list to the storage control unit 40 (Step S22). As the consumables list has been stored by the storage control unit 40 at the above-mentioned Step S14, the storage control unit 40 can extract the consumables list (Step S23).

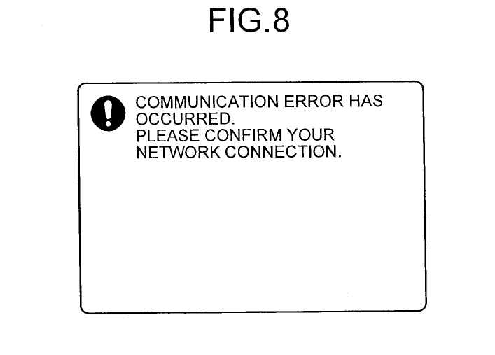

The processing unit 20 displays the consumables list and receives the order instruction from the user (Steps S15, S16). The processing unit 20 requests the storage control unit 40 to store the order information (Steps S24, S25). When the consumables list has not been stored in the image forming apparatus 1 in the state the network is not connected, that is, in the state of having never been connected to the network after the setup of the image forming apparatus 1, a dialog illustrated in FIG. 8 is displayed and the user is urged to confirm the network state.

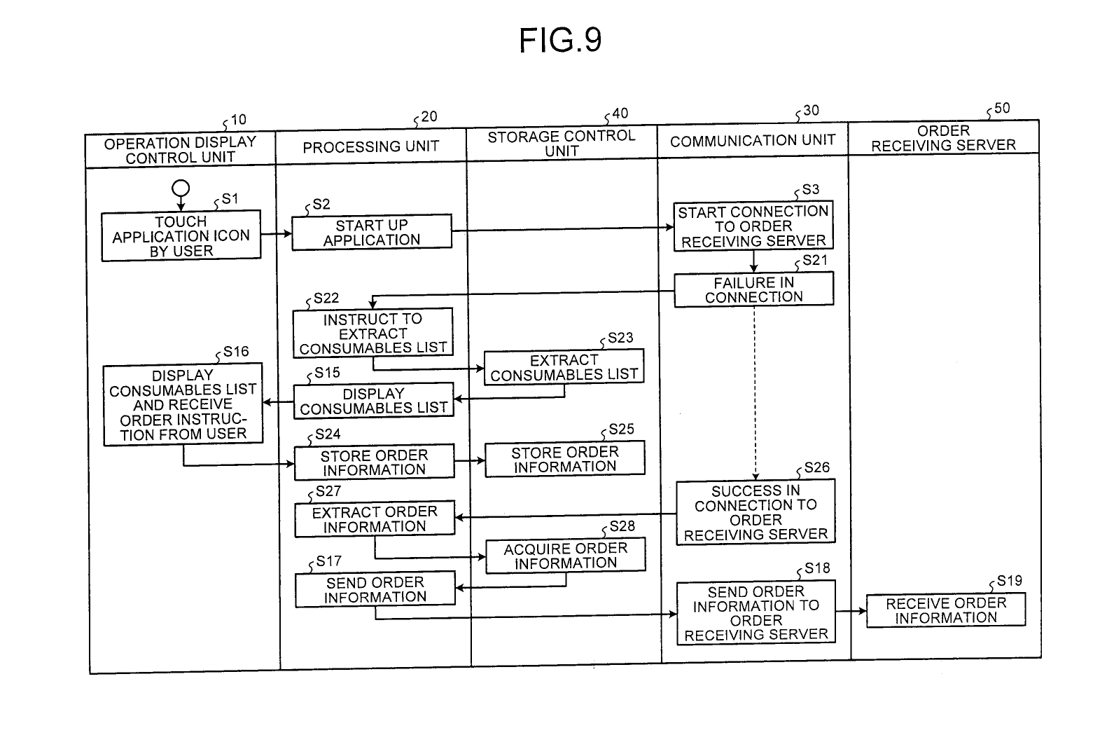

FIG. 9 illustrates a process after the network connection is recovered, in which an order is received in the state where the network connection is disconnected. When the connection to the order receiving server 50 is successfully recovered (Step S26), the processing unit 20 sends a command to acquire the order information stored by the storage control unit 40 from the storage control unit 40 (Step S27). In this manner, the communication unit 30 monitors whether the connection to the order receiving server 50 has been recovered or not. Then, when the recovery is detected, the communication unit 30 sends the notification to the processing unit 20. The storage control unit 40 acquires the order information from the non-volatile memory (ROM 112, HDD 114) (Step S28) and sends it to the processing unit 20.

The above-described image forming apparatus 1 according to the present embodiment can receive the order from the consumables list already stored even in the state of being not connected to the network. Then, the received order information is sent to the order receiving server 50 when the network is reconnected. Therefore, the user can perform an order work even in the state of being not connected to the network. As the order is placed along with the recovery of the network connection, it is possible to order the consumables regardless of the connection state of the network.

### Second Embodiment

In the first embodiment, the order information is sent instantly when the connection to the order receiving server 50 recovers. The second embodiment differs in performing a process, before sending the order information, of acquiring the consumables list from the order receiving server 50 and confirming if there is no difference between the consumables list from the order receiving server 50 and the consumables list stored in the device. The detailed process will be described below with reference to the drawings.

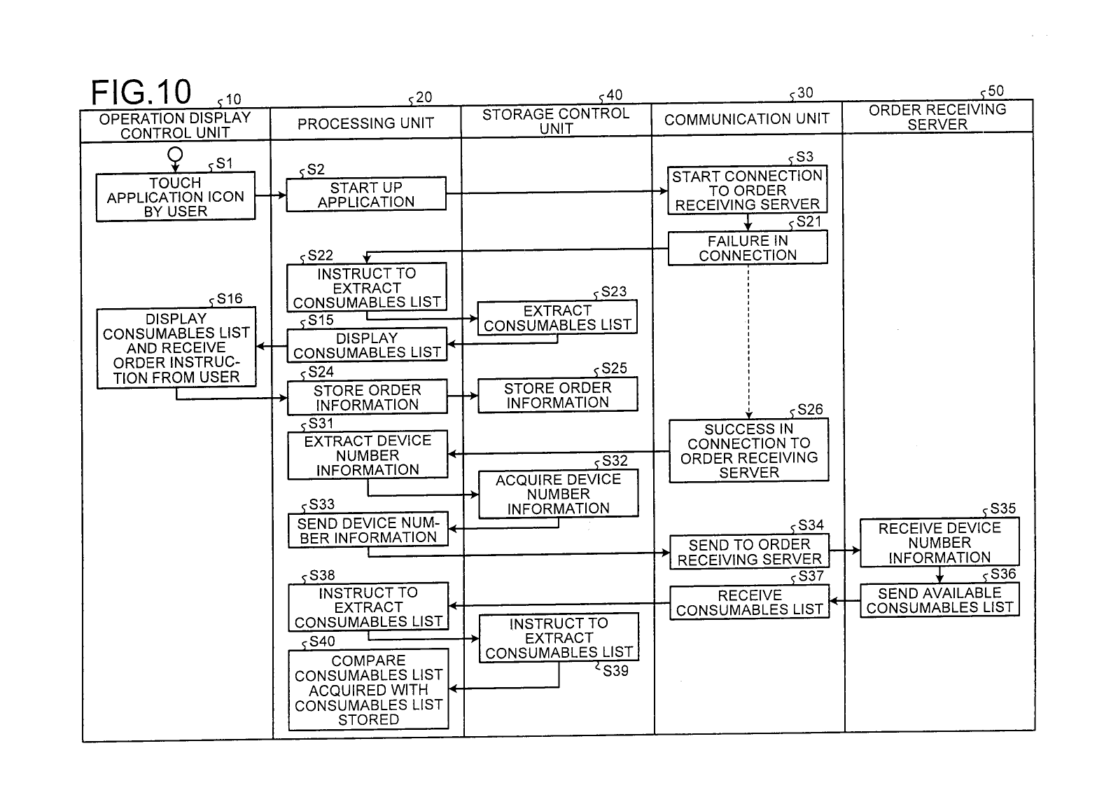

In FIG. 10, when the connection to the order receiving server 50 is recovered (Step S26), the processing unit 20 requests the storage control unit 40 to extract the device number information (Step S31). The storage control unit 40 acquires the device number information from the non-volatile memory (ROM 112, HDD 114) and returns it to the processing unit 20 (Step S32). The processing unit 20 sends the device number information to the order receiving server 50 via the communication unit 30 (Steps S33, S34). Upon receiving the device number information (Step S35), the order receiving server 50 sends the consumables list corresponding to the image forming apparatus 1 which is identified by the device number information (Step S36).

The image forming apparatus 1 receives a new consumables list via the communication unit 30 (Step S37), and the processing unit 20 instructs the storage control unit 40 to extract the previous consumables list already stored (Step S38). When the consumables list is sent from the storage control unit 40 (Step S39), the processing unit 20 compares a new consumables list acquired with the previous consumables list stored (Step S40).

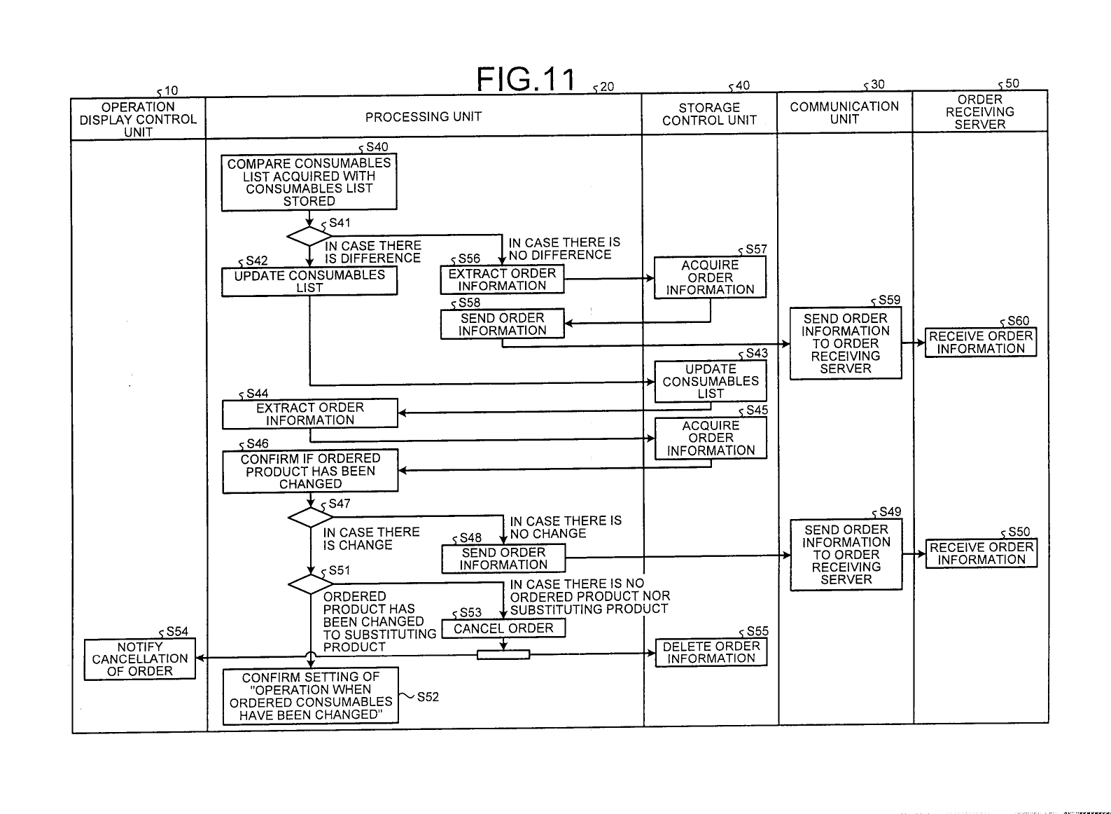

FIG. 11 is a flow after comparing the consumables lists. Then, the processing unit 20 determines whether there is a difference between the compared consumables lists (Step S41). In a case where there is a difference, the processing unit 20 instructs the storage control unit 40 to update the consumables list to a new one (Steps S42, S43). Then, the processing unit 20 instructs the storage control unit 40 to extract the order information which has been received in the state where the network connection cannot be connected as described above (Steps S44, S45). Then the processing unit 20 confirms whether there are any changes in ordered products based on the acquired order information and the updated consumables list (Step S46), and determines whether there are any changes (Step S47). In a case where there are any changes, the processing unit 20 determines whether a substituting product has been set to the ordered product (Step S51). As a method of setting the substituting product, a substitutable product is set for each product. For example, when a product is deleted from the consumables list, a substituting product is searched for and the substituting product for the original product is set.

When the substituting product has been set, the processing unit 20 confirms an operation setting when ordered consumables are changed (Step S52). The operation setting when the ordered consumables are changed will be described later. On the other hand, in a case where there is no ordered product nor the substituting product, the processing unit 20 performs the cancellation processing of the order (Step S53). In the cancellation processing, the storage control unit 40 deletes the order information (Step S55) and sends the notification of cancellation to the operation display control unit 10 (Step S54).

In a case where there are no changes in the ordered product in Step S47, the processing unit 20 sends the order information to the order receiving server 50 via the communication unit 30 (Steps S48 to S50).

In a case where there is no difference between the lists in Step S41, the processing unit 20 performs a process to extract the order information from the storage control unit 40 (Steps S56, S57). Then, the processing unit 20 sends the extracted order information to the order receiving server 50 via the communication unit 30 (Steps S58 to S60).

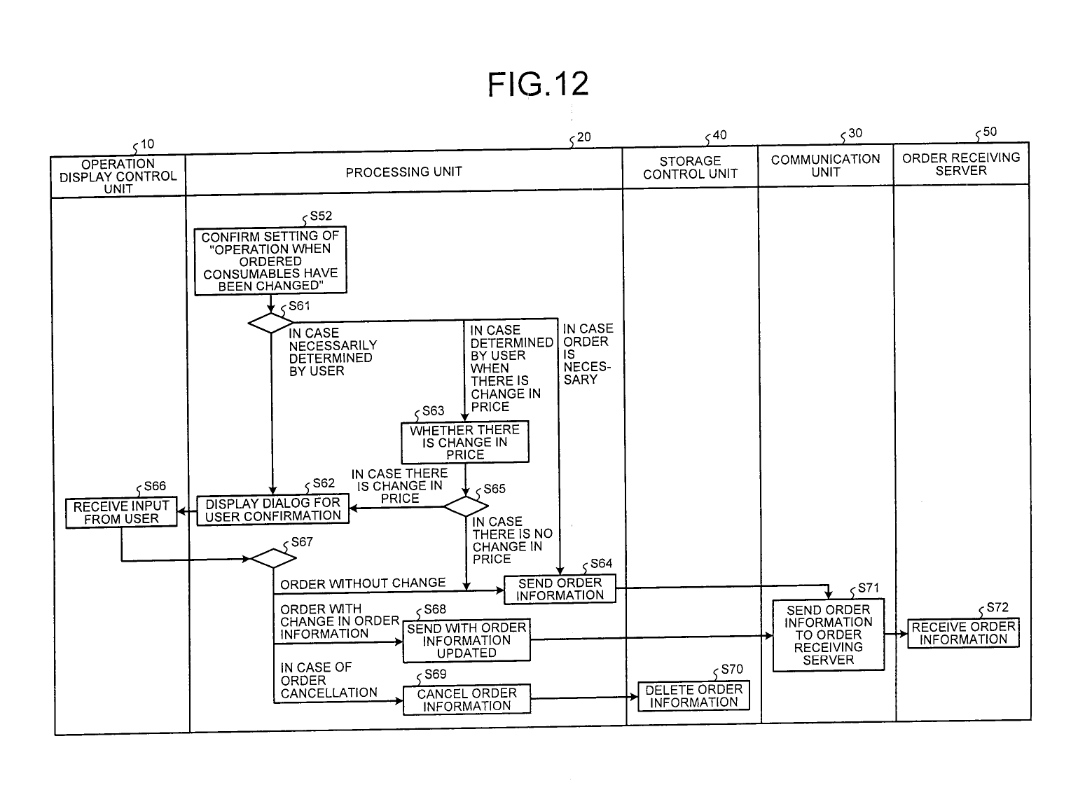

Next, the details of the operation when the ordered consumables have been changed will be described using FIG. 12. First, the processing unit 20 confirms a process setting when the ordered consumables have been changed to the substituting product (Step S61). When the setting necessarily requires a decision of the user, the processing unit 20 instructs the operation display control unit 10 to display the dialog to urge the user to do confirmation (Step S62). The operation display control unit 10 receives the input from the user (Step S66) and the processing unit 20 determines the content input from the user (Step S67). When the input is the same as the order instruction, the processing unit 20 sends the order information to the order receiving server 50 via the communication unit 30 (Steps S64, S71, S72).

When the input is an order accompanying changes in the order information, the processing unit 20 updates the order information and sends it to the order receiving server 50 (Step S68). When the input is the cancellation of the order, the processing unit 20 cancels the order information (Step S69), and deletes the order information via the storage control unit 40 (Step S70).

In Step S61, when the change to the substituting product from the canceled product is in an item set in advance, in the present embodiment when a price is changed, the processing unit 20 determines whether there is a change in price when it is set that the user determines (Steps S63, S65). The item set in advance may not necessarily be the price and may be other items, for example, capacity or size. If there is a change in price, the flow proceeds to Step S62. On the other hand, if there is no change in price, the flow proceeds to Step S64. When it is set that the order is necessarily conducted in Step S61, the flow proceeds to Step S64.

The image forming apparatus 1 of the present embodiment can perform a more flexible order work for consumables, when there is a change in the order information, such as ordering based on the setting and receiving the change from the user.

### Third Embodiment

In the first embodiment, it is possible to receive an ordering procedure when the network is disconnected; however, it is necessary to connect to the server at least once to achieve it. As the network has never been connected, it results in an error when the consumables list is not stored. Therefore, the present embodiment is configured to store the available consumables list not from the network, but from an external medium (an external storage medium).

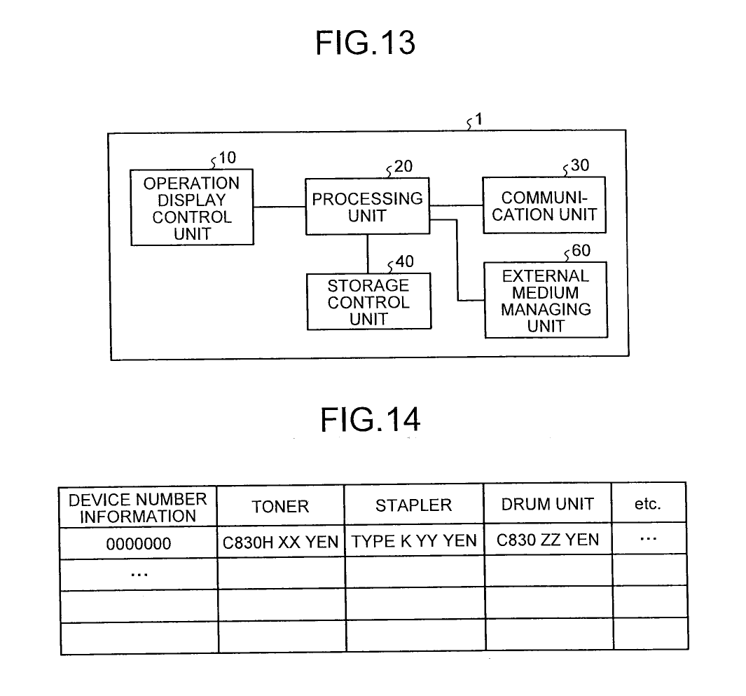

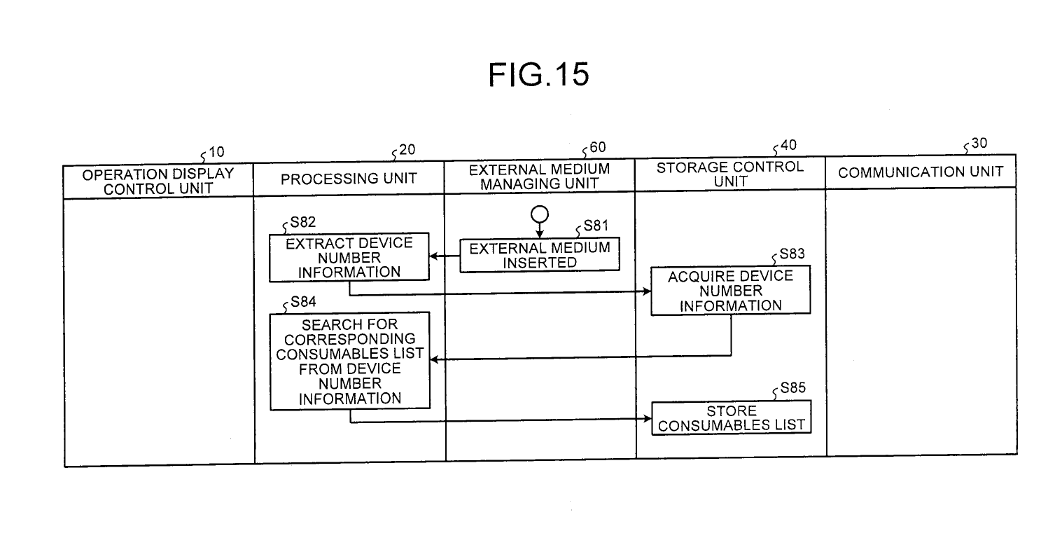

FIG. 13 illustrates a functional configuration diagram of an image forming apparatus 1 which newly includes an external medium managing unit 60. The external medium managing unit 60 detects the connection of an external medium, for example, an SD card or a USB memory stick and passes data of the consumables list stored therein to a processing unit 20. The device number information and the consumables list available in that device number as illustrated in FIG. 14 are stored in the external medium. Then, as illustrated in FIG. 15, when the external medium is inserted into the device, the external medium managing unit 60 detects the insertion (Step S81). When the insertion is detected, the processing unit 20 acquires the device number information via a storage control unit 40 (Steps S82, S83). The processing unit 20 extracts the consumables list available in the device in light of the device number information of the device and stores the list (Steps S84, S85). With this configuration, it will be possible to perform the ordering procedure without connecting to the network.

Although the above-described function of each unit of the image forming apparatus 1 is realized by executing the program stored in a storage device (for example, the ROM 112, the HDD 114, the ROM 122, and the flash memory 124) by the CPU (111 or 121), it is not limited thereto, and at least a part of the function of each unit of the image forming apparatus 1 may be realized by a dedicated hardware circuit (for example, a semiconductor integrated circuit).

In addition, although in the above embodiments the main body 110 and the operation unit 120 operate independently of each other by the different operating systems, it is not limited thereto and the main body 110 and the operation unit 120 may operate by the same operating system.

In addition, the programs executed by the image forming apparatus 1 of the above-described embodiments may be provided by being stored in a computer-readable storage medium such as a CD-ROM, a flexible disk (FD), a CD-R, a digital versatile disk (DVD), and a USB in an installable-format or executable-format file. The programs may also be provided or distributed via the network such as the Internet. The various programs may also be provided by being incorporated in advance in a non-volatile storage medium such as a ROM.

The programs executed by the information processing apparatus in each of the embodiments above are configured as module which includes the above-mentioned each unit. As the actual hardware, a CPU (processor) reads and executes the program from the storage medium, whereby each unit is loaded on the main storage device and formed in the main storage device.

In the above embodiments, the image forming apparatus of the present invention has been described using an example applied to a multifunction peripheral having at least two functions of the copy function, the printer function, the scanner function, and the facsimile function. However, it may be applied to any image forming apparatus such as a copy machine, a printer, a scanner, and a facsimile machine.

An embodiment provides the effects in which the user can perform the ordering procedures for consumables even when the network is disconnected.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a communication unit to be connected to an order receiving server via a network;
an operation display control unit that performs control of reception of an input from a user and display of data;
a storage control unit that stores, in a storage medium, device number information for identifying the information processing apparatus and a consumables list of consumables available in the information processing apparatus identified by the device number information, the consumables list being acquired from the order receiving server; and
a processing unit that acquires the consumables list from the order receiving server, instruct the operation display control unit to display the consumables list acquired, and send order information received from the user to the order receiving server when being connected to the network,
instructs the operation display control unit to display the consumables list stored and causes the storage control unit to store the order information received from the user when being not connected to the network, and
sends the order information stored to the order receiving server when the information processing apparatus is recovered from a state of being not connected to the network to a state of being connected to the network.

2. The information processing apparatus according to claim 1, wherein the processing unit notifies the user, via the operation display control unit, that it is necessary to connect to the network when the consumables list is not stored by the storage control unit.

3. The information processing apparatus according to claim 1, wherein, when the information processing apparatus is recovered from the state of being not connected to the network to the state of being connected to the network, the processing unit compares the consumables list stored with the consumables list newly acquired from the order receiving server, and when a product included in the order information stored is deleted from the consumables list newly acquired, the processing unit cancels an order of the product and displays a cancellation of the product on the operation display control unit.

4. The information processing apparatus according to claim 3,
wherein when a substituting product for the product which has been canceled is included in the consumables list newly acquired, the processing unit determines whether
it is set to instruct the operation display control unit to display the substituting product, receive the input from the user, and place an order in response to the input from the user,
it is set to instruct the operation display control unit to display the substituting product, receive the input from the user, and place an order in response to the input from the user when a change to the substituting product from the canceled product is in an item set in advance, and to place an order of the substituting product when the change is not in the item set in advance, or
it is set to order the substituting product without change, and
the processing unit places an order based on a result of the determination.

5. The information processing apparatus according to claim 1, comprising an external medium managing unit that detects an insertion/removal of an external storage medium to/from the information processing apparatus and acquire data from the external storage medium,
wherein the processing unit searches for an available consumables list using the device number information from the consumables list in the external storage medium, and causes the storage control unit to store the consumables list searched for.

6. A consumables ordering method comprising:
connecting to an order receiving server via a network;
receiving an input from a user and performing control to display data by an operation display control unit;
storing, in a storage medium, device number information for identifying an information processing apparatus and a consumables list of consumables available in the information processing apparatus identified by the device number information by a storage control unit, the consumables list being acquired from the order receiving server;
acquiring the consumables list from the order receiving server, instructing the operation display control unit to display the consumables list acquired, and sending order information received from the user to the order receiving server when being connected to the network;
instructing the operation display control unit to display the consumables list stored and causing the storage control unit to store the order information received from the user when being not connected to the network; and
sending the order information stored to the order receiving server when the information processing apparatus is recovered from a state of being not connected to the network to a state of being connected to the network.

7. A computer program product comprising a non-transitory computer-readable medium containing an information processing program, the program causing a computer included in an information processing apparatus to perform:
connecting to an order receiving server via a network;
receiving an input from a user and performing control to display data by an operation display control unit;
storing, in a storage medium, device number information for identifying an information processing apparatus and a consumables list of consumables available in the information processing apparatus identified by the device number information by a storage control unit, the consumables list being acquired from the order receiving server;
acquiring the consumables list from the order receiving server, instructing the operation display control unit to display the consumables list acquired, and sending order information received from the user to the order receiving server when being connected to the network;
instructing the operation display control unit to display the consumables list stored and causing the storage control unit to store the order information received from the user when being not connected to the network; and
sending the order information stored to the order receiving server when the information processing apparatus is recovered from a state of being not connected to the network to a state of being connected to the network.
